(19) United States
(12) Patent Application Publication
(10) Pub. No.: US 2019/0071359 A1
(43) Pub. Date: Mar. 7, 2019

(54) POLYCRYSTALLINE CUBIC BORON NITRIDE

(71) Applicant: ILJIN DIAMOND CO., LTD., Eumseong (KR)

(72) Inventors: Dong Kyun SHIN, Eumseong (KR); Hee Sub PARK, Eumseong (KR)

(73) Assignee: ILJIN DIAMOND CO., LTD., Eumseong (KR)

(21) Appl. No.: 16/090,232

(22) PCT Filed: Mar. 21, 2017
(86) PCT No.: PCT/KR2017/002983

§ 371 Date: Sep. 29, 2018

(30) Foreign Application Priority Data
Apr. 1, 2016 (KR) 10-2016-0040207

(51) Int. Cl. C04B 35/5831; C04B 35/63; C04B 35/645; B24D 3/14

(52) U.S. Cl. CPC C04B 35/5831; C04B 35/6303; C04B 35/645; B24D 3/14; C04B 2235/5436; C04B 2235/5445; C04B 2235/656; C04B 2235/5472; C04B 2235/386; C04B 2235/402; C04B 2235/3886; C04B 2235/3847; C04B 2235/762; C04B 2235/5454

(57) ABSTRACT

The present disclosure relates to polycrystalline cubic boron nitride (PCBN) with improved fracturing-resistance and wear-resistance. The polycrystalline cubic boron nitride is prepared using CBN particles of different particle sizes. In this way, the bonding force was increased by heat treatment of the second group CBN particles and binder. At the same time, improvements of the dispersion of the CBN particles of the first and second groups and the bonding force between the binder and cubic boron nitrides were achieved at the same time. Thus, the wear-resistance and fracturing-resistance of the PCBN can be effectively improved. Further, according to the present disclosure, preparing the polycrystalline cubic boron nitride by regulating the volume ratio between the charged CBN particles may allow the wear-resistance and fracturing-resistance of the PCBN to be improved. Thus, the machining tools with excellent lifetime can be manufactured using the PCBN.

### BACKGROUND

### 1. Field

The present disclosure relates to polycrystalline cubic boron nitride. More particularly, the present disclosure relates to polycrystalline cubic boron nitride (PCBN) with improved fracturing-resistance and wear-resistance.

### 2. Description of Related Art

With the advancement of industrial technology, it is required to improve the precision, performance and durability of cutting tools, dies or precision element mechanical parts. There is a growing demand for high-precision finish machining of high-hardness iron-based materials of various molding dies and sliding parts. Monocrystalline diamond and single crystal cubic boron nitride have been studied as precise processing elements for these iron-based materials. However, when cutting the iron-based material with the single crystal diamond, the chemical reaction between diamond and iron takes place via cutting heat. Thus, there occurs a problem that the diamond tool wears rapidly. Thus, it is impossible to directly process a metal mold made of a steel using the single crystal diamond. For this reason, for example, in the precision machining of a lens mold, electroless nickel plating is performed. Then, precisely finishing the plated layer has been adopted. However, when using this approach, the strength of the mold is insufficient and the process is complicated. In addition, direct machining has been studied by a chemical reaction suppression method using a special atmosphere. However, this may not be practical.

In general, boron nitride is typically present in following three crystal forms: cubic boron nitride (CBN), hexagonal boron nitride (hBN) and wurtztic boron nitride (wBN). Among them, the cubic boron nitride (CBN) is a hard zinc blend type of boron nitride having a structure similar to diamond. The bond formed between atoms in the cubic boron nitride structure is strong. These bonds are mainly tetrahedral shared bonds.

Further, cubic boron nitride (CBN) is the second hardest substance after diamond. Unlike diamonds, the CBN does not react with iron-based metals at high temperatures, and the CBN can be synthesized at low temperatures. The CBN is not oxidized even at a high temperature of about 1300 DEG C. The CBN is advantageously used as a surface coating material of a cutting tool. When grinding the iron-based material using the CBN based cutting tool, the CBN is excellent in chemical stability, has a high heat transfer rate, and is not easily worn by grinding heat. Thus, the grinding blade made of CBN is well maintained. As a result, CBN is widely used in machining of iron-based metals such as high-hardness heat-treated steel, tool steel, and cast iron.

The cubic boron nitride may be used in a form of polycrystalline cubic boron nitride (PCBN). Because diamond has the property of being oxidized with iron-based metals, polycrystalline cubic boron nitride is mainly used for machining of iron-based metals that cannot be machined with diamond. The PCBN is mostly used for cutting machining of the cast iron such as automobiles and various machine parts.

The polycrystalline cubic boron nitride (PCBN) may be prepared by mixing the cubic boron nitride (CBN) with a special ceramic material as a binder to form a mixture and then sintering the mixture. Recently, polycrystalline cubic boron nitride-based tools have been widely applied to difficult-to-cut workpieces such as high hardness heat treated steels, super heat resistant alloys and sintered metals. The polycrystalline cubic boron nitride-based tool that allows high-precision machining of the hardened materials may be an alternative to conventional grinding machining tools.

However, in the conventional polycrystalline cubic boron nitride, thermal cracking is likely to occur due to the severe load from the thermal cycle as occurring during the cutting process. The strength of the PCBN is lowered at the high temperature. Thus, it is impossible to obtain a sharp blade tip necessary for a precision cutting tool by using the PCBN. Thus, the life of the tool is not excellent. Therefore, it is urgent to study cutting tools having excellent fracturing-resistance and wear-resistance so as to minimize thermal cracking even at high temperatures.

### DISCLOSURE OF THE INVENTION

### Technical Purpose

The present disclosure is intended to provide polycrystalline cubic boron nitride by fabricating polycrystalline cubic boron nitride using CBN particles with different particle sizes such that it is possible to increase the bond force between the binder and CBN particles via reducing the gap between the CBN particles of different sizes.

Further, the present disclosure is intended to provide polycrystalline cubic boron nitride by defining the volume ratio between injected CBN particles and fabricating the polycrystalline cubic boron nitride based on the volume ratio, such that the fracturing-resistance and wear-resistance of the resulting PCBN are improved and the resulting PCBN may be used to manufacture tools with good lifetime.

### Technical Solution

In one aspect of the present disclosure, there is provided a polycrystalline cubic boron nitride (PCBN) containing a first group of cubic boron nitride (CBN) particles and a second group of CBN particles and a binder, wherein the cubic boron nitride (CBN) particles in the first group have different particle sizes from particle sizes of the cubic boron nitride (CBN) particles in the second group, wherein an average CBN particle size in the first group is 1 to 4 μm, wherein an average CBN particle size in the second group is 0.01 to 1 μm, wherein a total content of the CBN particles in the first group and the second group is 50 to 70 vol %, wherein a volume ratio between the CBN particles in the first group and the CBN particles in the second group is defined by following Relationship 1 and Relationship 2:

FIRST GROUP÷3≥SECOND GROUP Relationship 1:

(FIRST GROUP+SECOND GROUP)÷9<SECOND GROUP Relationship 2:

where FIRST GROUP indicates a content of the CBN particles in the first group, and SECOND GROUP indicates a content of the CBN particles in the second group.

In one embodiment, a binder contains transition metals of Group 4 and Group 5, and carbonitrides, nitro-carburized materials, oxides, or borides of Al, W, and Co metals, wherein the binder contains three or more kinds of complex solid solutions in a form of the carbonitrides, nitro-carburized materials, oxides, or borides.

In one embodiment, the polycrystalline cubic boron nitride (PCBN) is produced by mixing the CBN particles in the second group are with the binder to form a mixture, and by heat-treating the mixture, and, then, by mixing the heat-treated mixture with the CBN particles in the first group.

In one embodiment, the CBN particles in the first group and the second group and the binder are mixed with each other using one of ball mill, attritor mill, and planetary mill methods.

In one embodiment, the polycrystalline cubic boron nitride is sintered at 1200 to 1600° C. and at 3.5 to 6.5 GPa.

In one embodiment, an average CBN particle size in the first group is 1 to 4 μm, wherein an average CBN particle size in the second group is 0.01 to 1 μm.

In one embodiment, the average CBN particle size in the first group is 1.5 to 3.5 μm, wherein the average CBN particle size in the second group is 0.3 to 0.9 μm,

### Technical Effects

According to the present disclosure, the polycrystalline cubic boron nitride is prepared using CBN particles of different particle sizes. In this way, the bonding force was increased by heat treatment of the second group CBN particles and binder. At the same time, improvements of the dispersion of the CBN particles of the first and second groups and the bonding force between the binder and cubic boron nitrides were achieved at the same time. Thus, the wear-resistance and fracturing-resistance of the PCBN can be effectively improved.

Further, according to the present disclosure, preparing the polycrystalline cubic boron nitride by regulating the volume ratio between the charged CBN particles may allow the wear-resistance and fracturing-resistance of the PCBN to be improved. Thus, the machining tools with excellent lifetime can be manufactured using the PCBN.

### BRIEF DESCRIPTION OF THE DRAWINGS

FIG. 1 is a schematic diagram showing a state in which CBN particles of a second group are dispersed between CBN particles of a first group according to an embodiment of the present disclosure.

### DETAILED DESCRIPTIONS

The details of other embodiments are included in the detailed description and drawings.

The advantages and features of the present disclosure, and how to accomplish them, will become apparent with reference to the embodiments described in detail below with reference to the accompanying drawings. However, the present disclosure is not limited to the embodiments disclosed below but may be implemented in various other forms. In the following description, when a certain portion is connected to another portion, this includes not only the case where they are directly connected but also the case where they are connected via another medium therebetween. Further, parts of the drawing that do not relate to the present disclosure have been omitted to clarify the description of the present disclosure. Like parts are designated with like reference numerals throughout the specification.

Hereinafter, the present disclosure will be described in detail.

The following describes in more detail the polycrystalline cubic boron nitride according to one embodiment of the present disclosure.

The present disclosure relates to polycrystalline cubic boron nitride (PCBN) composed of CBN particles of a first group and a second group of different particle sizes and a binder. The average value of the CBN particle size of the first group is 1 to 4 μm. The average value of the CBN particle size of the second group is preferably 0.01 to 1 μm. When the average value of the CBN particle size of the first group is smaller than 1 μm and the average value of the CBN particle size of the second group is smaller than 0.01 μm, the size of CBN particles is too small, thereby to reduce wear-resistance of the polycrystalline cubic boron nitride. This is not preferable. Particularly, when the CBN particle size of the second group is smaller than 0.01 μm, during sintering, the bonding force between the CBN and the binder is rapidly lowered. When the bonding force is lowered, the hardness of the sintered body is lowered, which leads to a reduction in wear-resistance and the machining tool life is deteriorated.

Further, when the average value of the CBN particle size of the first group exceeds 4 μm and the average value of the CBN particle size of the second group exceeds 1 μm, the fracturing incidence rate of CBN is increased such that it is not possible to maintain the workpiece roughness well, which is not preferable. Generally, the larger the size of CBN particles, the more wear-resistance tends to be improved. As the CBN content increases, the wear-resistance tends to increase. However, if the size of CBN particles in the first group exceeds 4 μm, the incidence of fracturing in the CBN is increased such that the workpiece roughness cannot be maintained well. Thus, when the maximum size of CBN particles in the first group is smaller than 4 μm, the required roughness Ra of the workpiece during machining of the heat-treated steel can be maintained to be smaller than Ra 5 μm. Further, more preferably, the CBN particle size of the first group is 1.5 to 3.5 μm, while the CBN particle size of the second group is more preferably 0.3 to 0.9 μm.

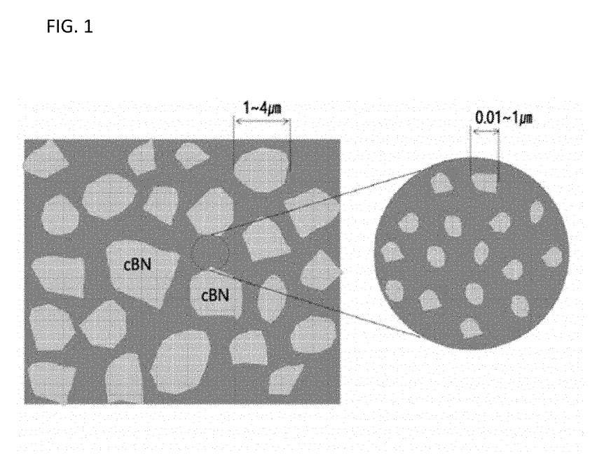

In the present disclosure, when CBN particles of the first group and second group having different particle sizes are sintered together with the binder, the CBN particles of the second group, which have a relatively small particle size are located in the gap between the CBN particles of the first group. As a result, this shows the effect of reducing the gap between the CBN particles. Further, the CBN particles of the second group are mixed with the binder to form mixture powders. Then, the mixture powders are heat treated. The heat-treated mixture powders were mixed with CBN particles of the first group. The resulting mixture is then sintered. Thereby, the present PCNB is produced. This gives the polycrystalline cubic boron nitride with enhanced dispersion between CBN particles in the first group and CBN particles in the second group. FIG. 1 is a schematic diagram showing a state in which CBN particles of the second group are dispersed between the CBN particles of the first group according to an embodiment of the present disclosure.

In the preparation of the polycrystalline cubic boron nitride of the present disclosure, prior to sintering, the binder is added and mixed to strengthen the bonds between the CBN particles of the first group and the second group. The mixing of the CBN particles and the binder is preferably performed using a ball mill, an attritor mill, or a planetary mill method. The mixing method between the CBN particles and the binder is not limited thereto. Any conventionally known method may be used as the mixing method.

According to the present disclosure, when the gap between the CBN particles is reduced using CBN particles of the first group and the second group having different particle sizes from each other, the amount of the binder added before sintering is further reduced. As a result, polycrystalline cubic boron nitride having excellent fracturing-resistance and hardness can be obtained. In the polycrystalline cubic boron nitride containing a large amount of binder, the hardness of the sintered body of the polycrystalline cubic boron nitride decreases. The lower the hardness of the sintered body of the polycrystalline cubic boron nitride is, the faster the wear of the machining tool occurs. As a result, the life of the machining tool is reduced.

Further, because the heat resistance of polycrystalline cubic boron nitride containing a large amount of binder is poor, the strength of the PCBN-based machining tool is lowered at high temperatures such that there is a problem that the machining tool is easily broken. Further, it is impossible to obtain a sharp blade tip due to the breakage of the machining tool due to the decrease in strength. As a result, the strength and wear resistance of the blade are not sufficient. The tool may be not suitable for a cutting machining tool.

In one embodiment, the total content of CBN particles in the first and second groups is 50 to 70 vol %. The volume ratio between the CBN particles of the first group and the CBN particles of the second group is preferably defined by the following Relationship 1 and Relationship 2:

FIRST GROUP÷3≥SECOND GROUP Relationship 1:

(FIRST GROUP+SECOND GROUP)÷9<SECOND GROUP Relationship 2:

(where FIRST GROUP: content of first group CBN particles, SECOND GROUP: content of second group CBN particles)

According to the present disclosure, when the total content of CBN particles in the first group and the second group is 50 to 70 vol %, the dispersion between the CBN particles of the first group, which are relatively large particles, and the CBN particles of the second group, which are relatively small particles may increase. During sintering, the degree of bonding of the CBN particles of the small second group is improved. Thus, the fracturing-resistance of the PCBN is improved. This makes it possible to manufacture a machining tool having an excellent service life. If the total content of CBN particles in the first group and second group is smaller than 50 vol %, the hardness of the polycrystalline cubic boron nitride is reduced, thereby shortening the life of the machining tool. If the total content of CBN particles in the first group and the second group exceeds 70 vol %, the hardness of the PCBN increases and its toughness improves, while the heat resistance of the PCBN may be deteriorated.

Further, the volume ratio between the CBN particles of the first group and the CBN particles of the second group is preferably within the range of the volume ratio defined in Relationship 1 and Relationship 2. If the volume ratio between the CBN particles of the first group and the CBN particles of the second group satisfy both Relationship 1 and Relationship 2, the bonding force between the CBN particles of the first group and the second group and the binder, and the independence of each of the CBN particles are enhanced. When the volume ratio between the CBN particles of the first group and the CBN particles of the second group does not satisfy the Relationship 1 and the Relationship 2, the life of the polycrystalline cubic boron nitride is reduced.

The polycrystalline cubic boron nitride according to the present disclosure comprises CBN particles of the first group and CBN particles of the second group and a binder bonding the particles. The binder contains transition metals of Group 4 and Group 5 and Al, W, and Co metals or carbonitrides, nitro-carburized materials, oxides, or borides thereof. There are three or more complex solid solutions or compounds in the form of carbonitrides, nitro-carburized materials, oxides, or borides. The mass ratio of the above three or more kinds of solid solution or compound is preferably within 5 wt % of the total mass of the binder.

Further, the polycrystalline cubic boron nitride of the present disclosure may be pressurized-produced under a pressure of 3.5 to 6.5 GPa per unit area in the temperature range of 1200 to 1600° C. If the temperature and pressure are lower than 1200 degree C. and lower than 3.5 GPa, in the manufacture of the polycrystalline cubic boron nitride, the cubic boron nitride may undergo a phase change to the hexagonal boron nitride, which is not desirable. When the temperature and pressure exceed 1600 DEG C. and 6.5 GPa, during sintering, phase change and degeneration may occur due to excessive reaction of the polycrystalline cubic boron nitride, which is undesirable.

As described above, the polycrystalline cubic boron nitride according to the present disclosure is manufactured using CBN particles of the first group and second group having different particle sizes. As a result, the heat resistance of the polycrystalline cubic boron nitride is improved. Further, the volume ratio and the total content between the CBN particles of the first group and the second group are optimally defined such that this makes it possible to manufacture the polycrystalline cubic boron nitride with the improved wear resistance, heat resistance and impact resistance. Thus, it becomes possible to manufacture a cutting machining tool having an excellent life span.

Accordingly, when a machining tool based on the present polycrystalline cubic boron nitride is used in machining of hard materials such as titanium alloy and superalloy, this PCNB-based machining tool has a better lifetime than the conventional polycrystalline cubic boron nitride-based machining tools.

Hereinafter, the present disclosure will be described in more detail with reference to the Present Examples.

### (Experiment Example 1) Life Time Test of Machining Tools Based on Total Content and Volume Ratio Between CBN Particles in First Group and Second Group

In Experiment Example 1 of the present disclosure, the applicant tested the life of a machining tool based on the total content and volume ratio between the CBN particles in the first and second groups for the polycrystalline cubic boron nitride in accordance with Present Examples. Hereinafter, the conditions for the Present Examples and the Comparative Examples in the present disclosure are as follows:

### Present Example 1

In Present Example 1, the CBN particle content of the first group is 54 vol %. The CBN particle content of the second group is 10 vol %. The total content of the CBN particles of the first group and the second group is 64 vol %. In this case, 9 vol % of Al, 25 vol % of TiCN and 2 vol % of WC were added together as a binder into the cubic boron nitride particles. The resulting mixture powders were mixed using a general ball mill process.

At the time of mixing, CBN of the second group are mixed with the binder. Then, the mixture is subjected to a vacuum heat treatment at a temperature of 650° C. or higher. After a first reaction occurs, the mixture is ball milled and mixed with the cubic boron nitride of the first group. During the ball milling process, the ball may be a WC ball.

After the mixed powders via the mixing process is shaped, de-waxing was performed at 500° C. to remove residual wax from the shaped body. Then, the shaped body thus treated was sintered at 1400 to 1500° C. under the condition of 5 to 6 GPa.

### Present Example 2

In Present Example 2, the CBN particle content of the first group is 45.00 vol %. The CBN particle content of the second group is 15.00 vol %. The total content of the CBN particles of the first group and the second group is 60.00 vol %. In this case, 10 vol % of Al and 30 vol % of TiCN were added together as a binder into the cubic boron nitride particles. The resulting mixture powders were mixed using a general ball mill process. During the ball milling process, the ball may be a WC ball.

At the time of mixing, CBN of the second group are mixed with the binder. Then, the mixture is subjected to a vacuum heat treatment at a temperature of 650° C. or higher. After a first reaction occurs, the mixture is ball milled and mixed with the cubic boron nitride of the first group. After the mixed powders via the mixing process is shaped, the shaped body thus treated was sintered at 1400 to 1500° C. under the condition of 5 to 6 GPa.

### Present Example 3

In Present Example 3, the CBN particle content of the first group is 50 vol %. The CBN particle content of the second group is 16 vol %. The total content of the CBN particles of the first group and the second group is 66 vol %. In this case, 9 vol % of Al, 24 vol % of TiN and 1 vol % of W were added together as a binder into the cubic boron nitride particles. The resulting mixture powders were mixed using a general ball mill process. During the ball milling process, the ball may be a WC ball.

At the time of mixing, CBN of the second group are mixed with the binder. Then, the mixture is subjected to a vacuum heat treatment at a temperature of 650° C. or higher. After a first reaction occurs, the mixture is ball milled and mixed with the cubic boron nitride of the first group. After the mixed powders via the mixing process is shaped, the shaped body thus treated was sintered at 1400 to 1550° C. under the condition of 5.5 to 6.5 GPa.

### Present Example 4

In Present Example 4, the CBN particle content of the first group is 44 vol %. The CBN particle content of the second group is 8 vol %. The total content of the CBN particles of the first group and the second group is 52 vol %. In this case, 19 vol % of Al and 29 vol % of TiN were added together as a binder into the cubic boron nitride particles. The resulting mixture powders were mixed using a general ball mill process. During the ball milling process, the ball may be a WC ball.

At the time of mixing, CBN of the second group are mixed with the binder. Then, the mixture is subjected to a vacuum heat treatment at a temperature of 650° C. or higher. After a first reaction occurs, the mixture is ball milled and mixed with the cubic boron nitride of the first group. After the mixed powders via the mixing process is shaped, the shaped body thus treated was sintered at 1450 to 1550° C. under the condition of 5.5 to 6.5 GPa.

### Comparative Example 1

In Comparative Example 1, the CBN particle content of the first group is 55 vol %. The CBN particle content of the second group is 6 vol %. The total content of the CBN particles of the first group and the second group is 60 vol %. In this case, 17 vol % of Al and 23 vol % of TiCN were added together as a binder into the cubic boron nitride particles. The resulting mixture powders were mixed using a general ball mill process. During the ball milling process, the ball may be a WC ball. The process after the mixing process was performed under the same conditions as in Present Example 1. Thereafter, sintering was carried out in the same manner as in Present Example 1 above.

### Comparative Example 2

In Comparative Example 2, the CBN particle content of the first group is 34 vol %. The CBN particle content of the second group is 30 vol %. The total content of the CBN particles of the first group and the second group is 64 vol %. In this case, 11 vol % of Al and 25 vol % of TiN were added together as a binder into the cubic boron nitride particles. The resulting mixture powders were mixed using a general ball mill process. During the ball milling process, the ball may be a WC ball. The process after the mixing process was performed under the same conditions as in Present Example 1. Thereafter, sintering was carried out in the same manner as in Present Example 1 above.

### Comparative Example 3

In Comparative Example 3, the CBN particle content of the first group is 58 vol %. The CBN particle content of the second group is 6 vol %. The total content of the CBN particles of the first group and the second group is 64 vol %. In this case, 11 vol % of Al and 25 vol % of TiCN were added together as a binder into the cubic boron nitride particles. The resulting mixture powders were mixed using a general ball mill process. During the ball milling process, the ball may be a WC ball. The process after the mixing process was performed under the same conditions as in Present Example 1. Thereafter, sintering was carried out in the same manner as in Present Example 1 above.

### Comparative Example 4

In Comparative Example 4, the CBN particle content of the first group is 35 vol %. The CBN particle content of the second group is 7 vol %. The total content of the CBN particles of the first group and the second group is 42 vol %. In this case, 21 vol % of Al and 37 vol % of TiN were added together as a binder into the cubic boron nitride particles. The resulting mixture powders were mixed using a general ball mill process. During the ball milling process, the ball may be a WC ball. The process after the mixing process was performed under the same conditions as in Present Example 1. Thereafter, sintering was carried out in the same manner as in Present Example 1 above.

### Comparative Example 5

In Comparative Example 5, the CBN particle content of the first group is 60 vol %. The CBN particle content of the second group is 20 vol %. The total content of the CBN particles of the first group and the second group is 80 vol %. In this case, 8 vol % of Al and 12 vol % of TiCN were added together as a binder into the cubic boron nitride particles. The resulting mixture powders were mixed using a general ball mill process. During the ball milling process, the ball may be a WC ball. The process after the mixing process was performed under the same conditions as in Present Example 1. Thereafter, sintering was carried out in the same manner as in Present Example 1 above.

Machining tools were fabricated using the sintered polycrystalline cubic boron nitrides according to the Present Examples and Comparative Examples. Then, workpieces were cut using these machining tools. As a result, the life of the machining tools was evaluated. In the Experiment Example 1, for each of Present Examples and Comparative Examples, the life of the machining tool was evaluated twice. Then, the measured lifetimes of the machining tools are averaged. The cutting test conditions for evaluating the life of each machining tool are as follows:

1) Life-span evaluation 1 of Machining Tools

<Cutting Test Conditions>

Workpiece: SUJ2 (diameter 50, length 150, cylindrical)

Machining tool type: CNGA120408

Cutting condition: cutting speed 250 m/min, transfer rate F0.5 mm/rev, cutting depth 0.05 mm, continuous machining under dry condition

2) Evaluation 2 of life-span of machining tool

<Cutting Test Conditions>

Workpiece: SUJ2 (50 mm in diameter, 50 mm in length, two V-grooves are defined by 180 degrees apart in cylindrical body)

Machining tool type: CNGA120408

Cutting conditions: cutting speed 200 m/min, transfer rate F0.5 mm/rev, cutting depth 0.05 mm, continuous machining under dry condition

Table 1 below is a table measuring the life of a cutting machining tool using the polycrystalline cubic boron nitrides, based on the total contents of the first and second group CBN particles and whether Relationship 1 and Relationship 2 are satisfied:

TABLE 1

| | | | Total content | | | Evaluation 1 of | Evaluation 2 of |
|---|---|---|---|---|---|---|---|
| | First group CBN | Second group CBN | of first group | Whether | Whether | life-span of | life-span of |
| | particle content | particle content | and second group | Relationship | Relationship | machining tool | machining tool |
| Examples | (vol %) | (vol %) | (vol %) | 1 is satisfied | 2 is satisfied | (cutting distance Km) | (cutting distance Km) |
| Present | 54 | 10 | ◯ | ◯ | ◯ | 6.3 | 4.0 |
| Example 1 | | | | | | | |
| Present | 45 | 15 | ◯ | ◯ | ◯ | 6.4 | 4.3 |
| Example 2 | | | | | | | |
| Present | 50 | 16 | ◯ | ◯ | ◯ | 6.1 | 4.1 |
| Example 3 | | | | | | | |
| Present | 44 | 8 | ◯ | ◯ | ◯ | 6.2 | 4.9 |
| Example 4 | | | | | | | |
| Comparative | 54 | 6 | ◯ | ◯ | X | 2.8 | 1.8 |
| Example 1 | | | | | | | |
| Comparative | 34 | 30 | ◯ | X | ◯ | 3.3 | 2.3 |
| Example 2 | | | | | | | |
| Comparative | 58 | 6 | ◯ | ◯ | X | 3.1 | 1.2 |
| Example 3 | | | | | | | |
| Comparative | 35 | 7 | X | ◯ | ◯ | 2.3 | 1.3 |
| Example 4 | | | | | | | |
| Comparative | 60 | 20 | X | ◯ | ◯ | 2.5 | 1.7 |
| Example 5 | | | | | | | |

1) Life-Span Testing of Machining Tools Based on Total Content of CBN Particles in First Group and Second Group

In Present Example 1 to Present Example 4 and Comparative Example 4 and Comparative Example 5, we change the total content of the CBN particles of the first group and the second group to measure the life of a machining tool based on the total content of CBN particles in the first and second groups.

Referring to Table 1, in the Present Example 1 to Present Example 4 of the present disclosure, the total content of CBN particles in the first group and second group is within the range of 50 to 70 vol %. In this case, from the life-span evaluation 1 of the machining tool, the lifetime of the machining tool is at least 6. In the life-span evaluation 2 of machining tool, the lifetime of machining tools is 4 or larger. This excellent lifetime was measured. For reference, the reason why the life of the machining tool in the life-span evaluation 2 of the machining tool is lower than the life of the machining tool in the life-span evaluation 1 of the machining tool is as follows: the workpiece used in the evaluation 2 of the life of the machining tool has V-grooves defined in the cylindrical body. As a result, the workpiece used in the life-span evaluation 2 of the machining tool is harder to machine than the workpiece in the life-span evaluation 1 of the machining tool.

In the case of Present Examples 1 to 4, when the total content of CBN particles in the first group and the second group is in the range of 50 to 70 vol %, the dispersion between the CBN particles of the first group, which is a relatively large particle, and CBN particles of the second group, which is a relatively small particle increases. The bonding degree of the CBN particles in the second group of small size particles is improved. Thus, the wear-resistance and fracturing-resistance of the resulting PCBN are improved. Thus, the life of the machining tool is excellent.

In the Comparative Examples contrasted with the above-described Present Example 1 to Present Example 4, particularly, in the case of Comparative Example 4, the total content of CBN particles in the first group and second group is out of the range defined according to the present disclosure and is 42 vol %. In this case, the life span of the machining tool of the life-span evaluation 1 of the machining tool is 2.3. Life expectancy of the machining tool in the life-span evaluation 2 of the machining tool was measured to be 1.3. These measurements are significantly lower than those in Present Example 1 to Present Example 4. If the total content of CBN particles in the first and second groups is smaller than 50 vol %, the hardness of the polycrystalline cubic boron nitride is reduced, shortening the life of the machining tool. In the above Comparative Example 4, the CBN particles total content of the first group and the second group is 42 vol %. This value is smaller than the total content specified in the present disclosure. As a result, the life span of the machining tool thereof is lower in both the life evaluations 1 and 2 of the machining tools.

In the Comparative Examples contrasted with the above-described Present Example 1 to Present Example 4, particularly, in the case of Comparative Example 5, the total content of CBN particles in the first group and second group is out of the range defined according to the present disclosure and is 80 vol %. In this case, the life span of the machining tool of the life-span evaluation 1 of the machining tool is 2.5. Life expectancy of the machining tool in the life-span evaluation 2 of the machining tool was measured to be 1.7. These measurements are significantly lower than those in Present Example 1 to Present Example 4. If the total content of CBN particles in the first and second groups is larger than 70 vol %, the hardness of the polycrystalline cubic boron nitride is increased, the hardness of the PCBN increases and its toughness improves, whereas the fracturing-resistance thereof deteriorates and is susceptible to wear due to heat. The machining tool may be easily damaged and hence the life of the machining tool is shortened. In the above Comparative Example 5, the CBN particles total content of the first group and the second group is 80 vol %. This value is larger than the total content as specified in the present disclosure. As a result, the life span of the machining tool thereof is lower in both the life evaluations 1 and 2 of the machining tools.

2) Life-Span Test of Machining Tools Based on Volume Ratio Between CBN Particles in First Group and Second Group

As for Present Example 1 to Present Example 4 and Comparative Examples 1 to 3, in the former case, the volume ratio between the CBN particles of the first group and the second group is satisfied based on the Relationships 1 and 2, while in the latter case, the volume ratio between the CBN particles of the first group and the second group is not satisfied based on the Relationships 1 and 2. Thus, the life-span of a machining tool based on the volume ratio between CBN particles in the first and second groups was measured.

Referring to Table 1, in Present Example 1 to Present Example 4 of the present disclosure, the volume ratio between the CBN particles of the first group and the second group satisfies the Relationship 1 and Relationship 2. In this case, the life-span of the machining tool in the life-span evaluation 1 of the machining tool 1 is above 6. The life-span of the machining tool in the life-span evaluation 2 of the machining tool 1 is above 4. The life-span of the machining tool may be excellent. In the Present Examples 1 to 4 where the volume ratio between the CBN particles of first group and second group satisfies the Relationship 1 and Relationship 2, the bonding forces between the CBN particles in the first group and the second group and the binder, and the independence of each of the CBN particles are enhanced, which is why the life-span of the machining tool is superior.

In the Comparative Examples contrasted with the above-described Present Example 1 to Present Example 4, particularly, in the case of the Comparative Examples 1 to 3, the volume ratio between the CBN particles of the first group and the second group does not satisfy the Relationship 1 and Relationship 2. In this case, the life-span of the machining tool in the life-span evaluation 1 of the machining tool 1 is in a range of 2 to 3. The life-span of the machining tool in the life-span evaluation 2 of the machining tool 1 is in a range of 1 to 2. The life-span of the machining tool may be poor compared to those in the Present Examples. This is because in the case of the Comparative Examples 1 to 3, the volume ratio between the CBN particles of the first group and the second group does not satisfy the Relationship 1 and Relationship 2, and, thus, the binding force between the binder and the CBN particles decreases. As a result, the impact resistance of the resulting PCBN is reduced and thus the life-span of the machining tool is degraded.

Those of ordinary skill in the art to which the present disclosure belongs may understand that the present disclosure may be embodied in other specific forms without departing from the spirit or essential characteristics thereof. It is therefore to be understood that the above-described embodiments are illustrative in all aspects and not restrictive. The scope of the present disclosure is defined by the claims set forth below rather than by the above detailed description. All changes or modifications that come within the meaning and range of the claims and the equivalents thereof are to be construed as being included within the scope of the present disclosure.

What is claimed is:

1. A polycrystalline cubic boron nitride (PCBN) containing a first group of cubic boron nitride (CBN) particles, a second group of CBN particles, and a binder, wherein the cubic boron nitride (CBN) particles in the first group have different particle sizes from particle sizes of the cubic boron nitride (CBN) particles in the second group,
wherein an average CBN particle size in the first group is 1 to 4 μm,
wherein an average CBN particle size in the second group is 0.01 to 1 μm,
wherein a total content of the CBN particles in the first group and the second group is 50 to 70 vol %,
wherein a volume ratio between the CBN particles in the first group and the CBN particles in the second group is defined by following Relationship 1 and Relationship 2:
FIRST GROUP÷3≥SECOND GROUP Relationship 1:
(FIRST GROUP+SECOND GROUP)÷9<SECOND GROUP Relationship 2:
where FIRST GROUP indicates a content of the CBN particles in the first group, and SECOND GROUP indicates a content of the CBN particles in the second group.

2. The polycrystalline cubic boron nitride (PCBN) of claim 1, wherein a binder contains transition metals of Group 4 and Group 5, and carbonitrides, nitro-carburized materials, oxides, or borides of Al, W, and Co metals,
wherein the binder contains three or more kinds of complex solid solutions in a form of the carbonitrides, nitro-carburized materials, oxides, or borides.

3. The polycrystalline cubic boron nitride (PCBN) of claim 1, wherein the polycrystalline cubic boron nitride (PCBN) is produced by mixing the CBN particles in the second group are with the binder to form a mixture, and by heat-treating the mixture, and, then, by mixing the heat-treated mixture with the CBN particles in the first group.

4. The polycrystalline cubic boron nitride (PCBN) of claim 1, wherein the CBN particles in the first group and the second group and the binder are mixed with each other using one of ball mill, attritor mill, and planetary mill methods.

5. The polycrystalline cubic boron nitride (PCBN) of claim 1, wherein the polycrystalline cubic boron nitride is sintered at 1200 to 1600° C. and at 3.5 to 6.5 GPa.

6. The polycrystalline cubic boron nitride (PCBN) of claim 1, wherein the average CBN particle size in the first group is 1.5 to 3.5 μm, wherein the average CBN particle size in the second group is 0.3 to 0.9 μm.
